(19) United States
(12) Patent Application Publication
(10) Pub. No.: US 2006/0002137 A1
(43) Pub. Date: Jan. 5, 2006

(54) Liquid crystal display apparatus

(76) Inventors: Choong-Sik Kim, Anyang-si (KR); Tae-Gil Kang, Suwon-si (KR); Yong-Woo Lee, Suwon-si (KR)

Correspondence Address: F. CHAU & ASSOCIATES, LLC, 130 WOODBURY ROAD, WOODBURY, NY, 11797, US

(21) Appl. No.: 11/127,048

(22) Filed: May 11, 2005

(30) Foreign Application Priority Data
May 11, 2004 (KR) 2004-33151

(51) Int. Cl. F21V 7/04

(52) U.S. Cl. 362/600

(57) ABSTRACT

An LCD apparatus includes a light guide plate; a lamp unit placed along at least one side of the light guide plate; and a lamp holder including a lamp supporting portion supporting opposite ends of the lamp unit, and a light guide plate supporting portion for supporting the light guide plate to prevent the light guide plate from contacting the lamp unit.

### CROSS-REFERENCE TO RELATED APPLICATIONS

This application claims the benefit of Korean Patent Application No. 2004-0033151, filed on May 11, 2004, in the Korean Intellectual Property Office, the disclosure of which is incorporated herein by reference.

### BACKGROUND OF THE INVENTION

1. Technical Field

The present disclosure relates to a liquid crystal display, and more particularly, a liquid crystal display (LCD) apparatus using a lamp holder to prevent contact between a light guide plate and a lamp unit.

2. Discussion of the Related Art

Generally, an LCD apparatus changes transmissivity of liquid crystal cells arranged in a matrix according to video signals, thereby displaying a picture on an LCD panel.

Such an LCD apparatus does not emit light for itself, so that a backlight assembly is additionally needed to illuminate the LCD panel displaying a picture.

The backlight assembly is classified into a direct type, where a lamp is located as a light source behind the LCD panel and directly emits light to the LCD panel, and an edge type, where the lamp is placed along at least one edge of a light guide plate located behind the LCD panel and indirectly emits the light to the LCD panel via the light guide plate.

In the case of the edge type LCD apparatus, the backlight assembly comprises a lamp unit functioning as the light source, and the light guide plate guiding the light of the lamp unit to the LCD panel therethrough.

However, because the lamp unit is placed along the light guide plate, contact between the lamp unit and the light guide plate may damage the lamp unit, thereby making the LCD apparatus defective.

### SUMMARY OF THE INVENTION

Accordingly, it is an aspect of the present invention to provide an LCD apparatus using a lamp holder to effectively prevent contact between a light guide plate and a lamp unit.

An LCD apparatus, according to an embodiment of the present invention, comprises a light guide plate; a lamp unit placed along at least one side of the light guide plate; and a lamp holder comprising a lamp supporting portion for supporting opposite ends of the lamp unit, and a light guide plate for supporting portion supporting the light guide plate to prevent the light guide plate from contacting the lamp unit.

The light guide plate supporting portion may be coupled to the lamp supporting portion.

The light guide plate supporting portion may have an approximately U-shaped section and be fitted to the lamp supporting portion.

The light guide plate supporting portion may comprise a front portion contacting the light guide plate, and side portions extending and bending from opposite ends of the front portion.

The lamp supporting portion may include a relatively soft material, and the light guide plate supporting portion may include a relatively hard material.

The light guide plate supporting portion may include a metallic material.

The light guide plate supporting portion may form a single body with the lamp supporting portion.

An LCD apparatus, according to an embodiment of the present invention, comprises a light guide plate; a light source placed along at least one side of the light guide plate; and a light source holder comprising a first portion for supporting at least one end of the light source, and a second portion for preventing the light guide plate from contacting the light source.

The second portion may be coupled to the first portion, may include an approximately U-shaped section and may be fitted around the first portion. The second portion may include a front portion for contacting the light guide plate, and side portions extending from opposite ends of the front portion in a direction approximately perpendicular to the front portion.

The first portion may be formed from a softer material than the second portion, wherein the second portion includes a metallic material.

The first and second portions may be integrated in a single body.

### BRIEF DESCRIPTION OF THE DRAWINGS

Preferred embodiments of the present invention can be understood in more detail from the following descriptions taken in conjunction with the accompanying drawings of which:

FIG. 1 is an exploded perspective view of a liquid crystal display according to an embodiment of the present invention;

FIG. 2 is a partial view illustrating a lamp holder supporting a lamp unit and a light guide plate in the liquid crystal display of FIG. 1;

FIG. 3 is an exploded perspective view of a backlight assembly used in a liquid crystal display according to an embodiment of the present invention; and

FIG. 4 is a section view of the liquid crystal display, taken along line IV-IV of FIG. 3.

### DETAILED DESCRIPTION OF THE PREFERRED EMBODIMENTS

Preferred Embodiments of the invention will be described below in more detail with reference to the accompanying drawings, wherein like reference numerals refer to like elements throughout. This invention may, however, be embodied in different forms and should not be construed as limited to the embodiments set forth herein. Rather, these embodiments are provided so that this disclosure will be thorough and complete, and will fully convey the scope of the invention to those skilled in the art. Hereinafter, an edge type LCD apparatus will be described representatively.

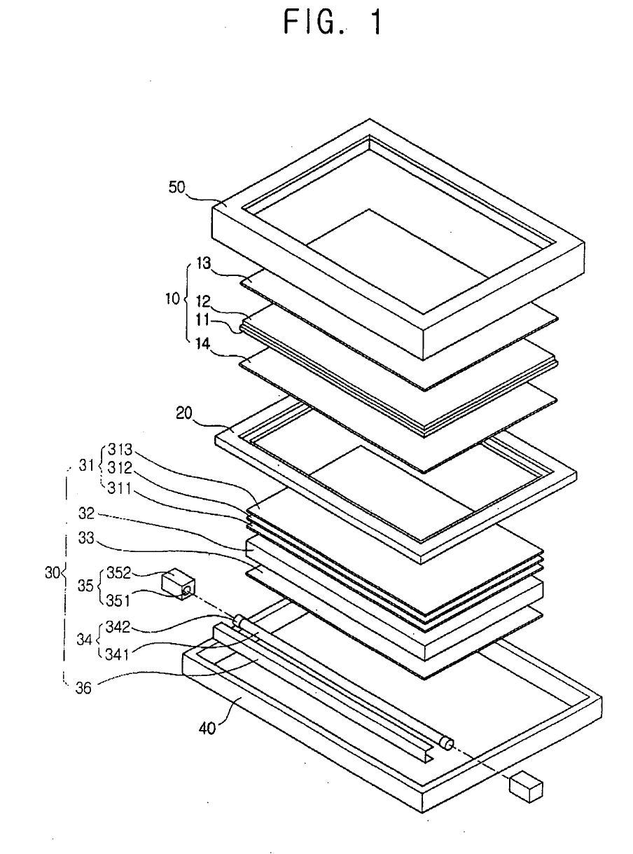

As shown in FIG. 1, an LCD apparatus according to a an embodiment of the present invention comprises an LCD panel 10 for displaying a picture thereon, a driver integrated circuit (not shown) driving the LCD panel 10, a mold frame 20 supporting edges of the LCD panel 10, a backlight assembly 30 emitting light to the LCD panel 10, a rear chassis 40 accommodating the backlight assembly 30 therein and supporting the mold frame 20, and a front chassis 50 coupled with the rear chassis 40 and covering front edges of the LCD panel 10.

The LCD panel 10 comprises a thin film transistor (TFT) array panel 11, a color filter panel 12 opposite to the TFT array panel 11, and liquid crystal (not shown) sandwiched between the TFT panel 11 and the color filter panel 12. Here, the TFT panel 11 and the color filter panel 12 are filled with liquid crystal therebetween and then sealed. Further, the LCD panel 10 comprises a front polarizing plate 13 attached to the front of the color filter panel 12, and a rear polarizing plate 14 attached to the rear of the TFT panel 11. In the LCD panel 10, liquid crystal cells are arranged in a matrix to form pixels, and changed in transmissivity according to video signals transmitted from the driver integrated circuit, thereby displaying a picture.

The mold frame 20 is rectangularly shaped along the edges of the LCD panel 10 and supports the LCD panel 10 such that the LCD panel 10 is spaced from the backlight assembly 30.

The backlight assembly 30 comprises a light guide plate 32 disposed in parallel with the LCD panel 10, a lamp unit 34 provided along at least one side of the light guide plate 32 and emitting light to the light guide plate 32, and a lamp holder 35 supporting the lamp unit 34 and the side of the light guide plate 32 adjacent to the lamp unit 34.

Further, the LCD apparatus comprises a lamp reflector 36 accommodating the lamp unit 34 therein and reflecting the light emitted from the lamp unit 34 toward the light guide plate 32, an optical sheet 31 placed in front of the light guide plate 32 and diffusing/concentrating the light emitted toward the LCD panel 10, and a reflecting sheet 33 placed at the rear of the light guide plate 32.

The light guide plate 32 has an incident surface to receive the light from the lamp unit 34, an emitting surface being at a right angle to the incident surface and in parallel with the LCD panel 10, and a rear surface formed with a pattern and guiding the light emitted from the lamp unit 34 toward the emitting surface. Thus, the light guide plate 32 receives the light from the lamp unit 34 through the incident surface, and uniformly emits the light to the LCD panel 10 through the emitting surface. Preferably, the light guide plate 32 is made of a material having sufficient strength and sufficient transmissivity such that the light guide plate 32 is not easily deformed and broken, for example, polymethylmethacrylate (PMMA).

The lamp unit 34 comprises a lamp 341 emitting the light, and a terminal 342 provided at an end of the lamp 341. The terminal 342 is connected to an inverter (not shown) and allows the lamp 341 to receive electric power.

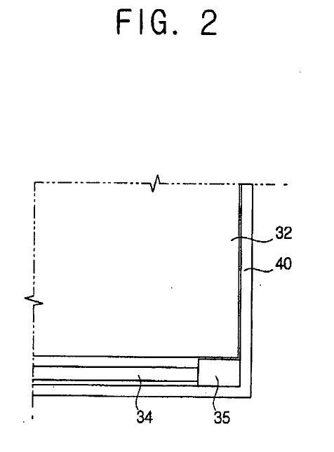

The lamp holder 35 protects the connection of the terminal 342 of the lamp unit 34 and the inverter. The lamp holder 35 comprises a lamp supporting portion 351 supporting opposite ends of the lamp unit 34, and a light guide plate supporting portion 352 supporting the side of the light guide plate 32 adjacent to the lamp unit 34, thereby preventing the light guide plate 32 from contacting the lamp unit 34. As shown in FIG. 2, the lamp supporting portion 351 and the light guide plate supporting portion 352 are formed as a single body, thereby preventing the light guide plate 32 from contacting the lamp unit 34.

The optical sheet 31 comprises a diffusing sheet 311 for diffusing the light traveling from the light guide plate 32 toward the LCD panel 10 and for preventing the LCD panel 10 from blemishes in order to enhance uniformity of the light, and a prism sheet 312 for allowing the light passing through the diffusing sheet 311 to travel perpendicularly to the optical sheet 31 in order to enhance brightness. Further, the optical sheet 31 additionally comprises a protective sheet 313 to protect the diffusing sheet 311 and the prism sheet 312 from dust, scratches, external impact, foreign material.

The reflecting sheet 33 reflects the light that travels in an opposite direction of the LCD panel 10, toward the light guide plate 32, thereby reducing loss in light and enhancing uniformity of the light.

With this configuration, in the LCD apparatus according to an embodiment of the present invention, the lamp holder 35 supporting the lamp unit 34 prevents the light guide plate 32 from contacting the lamp unit 34 as shown in FIG. 2, thereby decreasing damage due to the contact between the lamp unit 34 and the light guide plate 32. That is, the light guide plate 32 is prevented from contacting the lamp unit 34 by the lamp holder unit 35 without using an additional stopper, so that the light guide plate 32 and the lamp unit 34 are effectively protected by a simpler configuration.

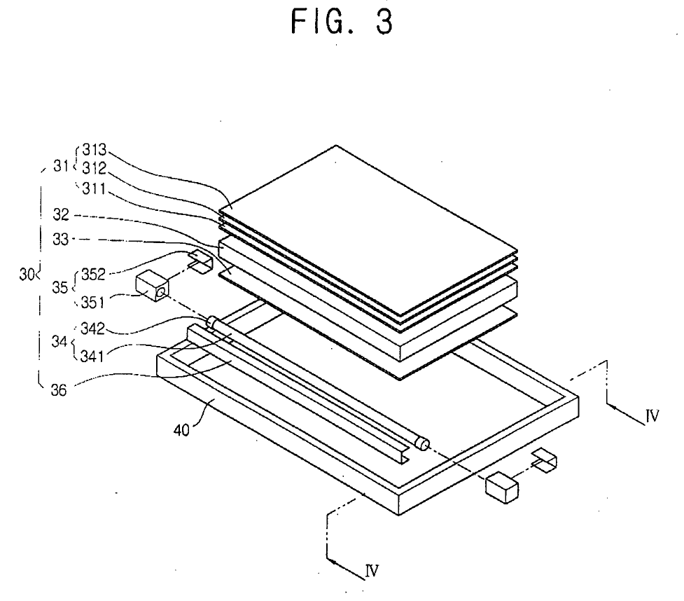

According to an embodiment of the present invention, as shown in FIG. 3, an LCD apparatus comprises a lamp holder 35 comprising a lamp supporting portion 351 made of a relatively soft material, and a light guide plate supporting portion 352 made of a relatively hard material and coupled to the lamp supporting portion 351.

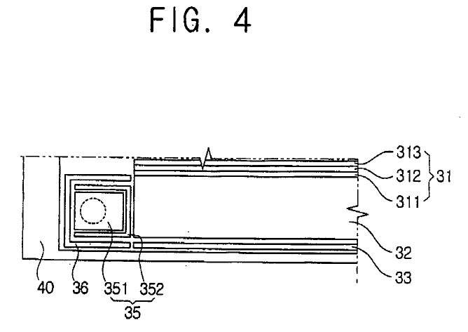

As shown in FIGS. 3 and 4, for example, the light guide plate supporting portion 352 is made of a thin metal plate having an approximately U-shaped section, and surrounds the lamp supporting portion 351 with respect to a surface of the lamp supporting portion 351 opposite the light guide plate 32.

That is, the light guide plate supporting portion 352 comprises a front portion positioned opposite to and capable of enduring impact from the light guide plate 32, and a pair of side portions extending and bending from opposite ends of the front portion.

The shape of the light guide plate supporting portion 352 is not limited to the U-shaped section, and may vary as long as it endures the impact due to the contact with the light guide plate 32.

In the LCD apparatus according to an embodiment of the present invention, the lamp supporting portion 351 is made of a relatively soft material in consideration of assemblage or the like, and the light guide plate supporting portion 352 is made of a relatively hard material to stably support the light guide plate 32 and prevent the light guide plate 32 from contacting the lamp unit 34. That is, the lamp supporting portion 351 and the light guide plate supporting portion 352 are made of soft and hard materials, respectively, and then coupled to each other, thereby forming the lamp holder 35.

Alternatively, the lamp supporting portion 351 and the light guide plate supporting portion 352 may be formed as a single body, wherein the guide plate supporting portion 352 is harder than the lamp supporting portion 351.

As described above, the present invention provides an LCD apparatus using a lamp holder to effectively prevent contact between a light guide plate and a lamp unit.

Although the illustrative embodiments of the present invention have been shown and described herein with reference to the accompanying drawings, it will be appreciated by those skilled in the art that the present invention is not limited to those precise embodiments, and that changes may be made without departing from the principles and spirit of the invention. All such changes and modifications are intended to be included within the scope of the invention as defined by the appended claims.

What is claimed is:

1. An LCD apparatus comprising:
a light guide plate;
a lamp unit placed along at least one side of the light guide plate; and
a lamp holder comprising a lamp supporting portion for supporting opposite ends of the lamp unit, and a light guide plate supporting portion for supporting the light guide plate to prevent the light guide plate from contacting the lamp unit.

2. The LCD apparatus according to claim 1, wherein the light guide plate supporting portion is coupled to the lamp supporting portion.

3. The LCD apparatus according to claim 2, wherein the light guide plate supporting portion includes an approximately U-shaped section and is fitted to the lamp supporting portion.

4. The LCD apparatus according to claim 3, wherein the light guide plate supporting portion comprises a front portion for contacting the light guide plate, and side portions extending and bending from opposite ends of the front portion.

5. The LCD apparatus according to claim 1, wherein the lamp supporting portion includes a soft material, and the light guide plate supporting portion includes a hard material.

6. The LCD apparatus according to claim 1, wherein the light guide plate supporting portion includes a metallic material.

7. The LCD apparatus according to claim 1, wherein the light guide plate supporting portion forms a single body with the lamp supporting portion.

8. An LCD apparatus comprising:
a light guide plate;
a light source placed along at least one side of the light guide plate; and
a light source holder comprising a first portion for supporting at least one end of the light source, and a second portion for preventing the light guide plate from contacting the light source.

9. The LCD apparatus according to claim 8, wherein the second portion is coupled to the first portion.

10. The LCD apparatus according to claim 8, wherein the second portion includes an approximately U-shaped section and is fitted around the first portion.

11. The LCD apparatus according to claim 10, wherein the second portion comprises a front portion for contacting the light guide plate, and side portions extending from opposite ends of the front portion.

12. The LCD apparatus according to claim 11, wherein the side portions extend in a direction approximately perpendicular to the front portion.

13. The LCD apparatus according to claim 8, wherein the first portion is formed from a softer material than the second portion.

14. The LCD apparatus according to claim 8, wherein the second portion includes a metallic material.

15. The LCD apparatus according to claim 8, wherein the first and second portions are integrated in a single body.
